(19) United States
(12) Patent Application Publication
(10) Pub. No.: US 2007/0004280 A1
(43) Pub. Date: Jan. 4, 2007

(54) Universal serial bus connector

(75) Inventor: Zheng-Heng Sun, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/344,460

(22) Filed: Jan. 30, 2006

(30) Foreign Application Priority Data
Jun. 30, 2005 (CN) 200520060925.1

(51) Int. Cl. H01R 13/40

(52) U.S. Cl. 439/594

(57) ABSTRACT

A Universal Serial Bus (USB) connector includes a main body, a plug with four signal pins, a plug module, and a cable. The plug is formed in the plug module. The plug module is mounted to the main body. The cable is linked to the main body and electronically connected to the signal pins of the plug. It is simple and economical to replace any components of the USB connector expediently.

### BACKGROUND OF THE INVENTION

1. Field of the Invention

The present invention relates to an electric connector, and particularly to a Universal Serial Bus (USB) connector.

2. General Background

To facilitate the linking of various external peripheral devices with different system terminals, four major international companies (including Compaq, Intel, Microsoft and NEC) have developed the USB interface in 1998. Ever since the Microsoft Windows 98 operating system started to provide built-in program for driving USB interface peripheral devices, the use of these peripheral products is facilitated. As a result, the applications of USB products have been expanding gradually.

FIG. 5 discloses a conventional USB connector. The USB connector 10 includes a main body 12, a plug 14 and a cable 16. The plug 14 includes four signal pins 14a, 14b, 14c and 14d. However, the USB connector 10 as shown in FIG. 5 is an integrative USB connector. When the main body 12 or is the plug 14 of the USB connector 10 is unexpectedly damaged, the USB connector 10 must be replaced entirely.

What is needed is a USB connector that can divide into some pieces, and replace expediently.

### SUMMARY

An exemplary USB connector includes a main body, a plug with four signal pins, a plug module, and a cable. The plug is formed in, the plug module. The plug module is mounted to the main body. The cable is linked to the main body and electronically connected to the signal pins of the plug.

It is simple and economical to replace any components of the USB connector expediently.

Other advantages and novel features will become more apparent from the following detailed description when taken in conjunction with the accompanying drawings, in which:

### BRIEF DESCRIPTION OF THE DRAWINGS

FIG. 1 is an exploded perspective view of a USB connector in accordance with a first preferred embodiment of the present invention;

FIG. 2 is an assembled view of FIG. 1;

FIG. 3 is an exploded perspective view of a USB connector in accordance with a second preferred embodiment of the present invention;

FIG. 4 is an assembled view of FIG. 3; and

FIG. 5 is an isometric view of a conventional USB connector.

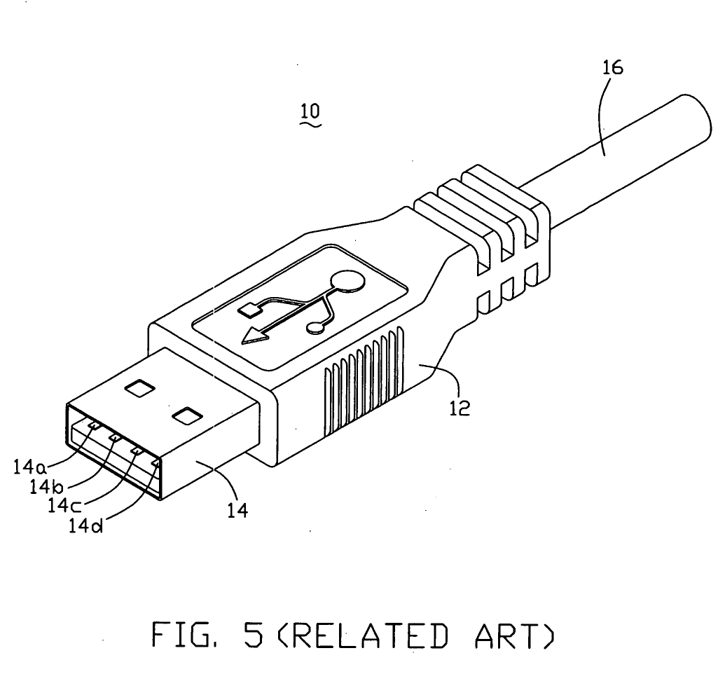

### DETAILED DESCRIPTION OF THE EMBODIMENT

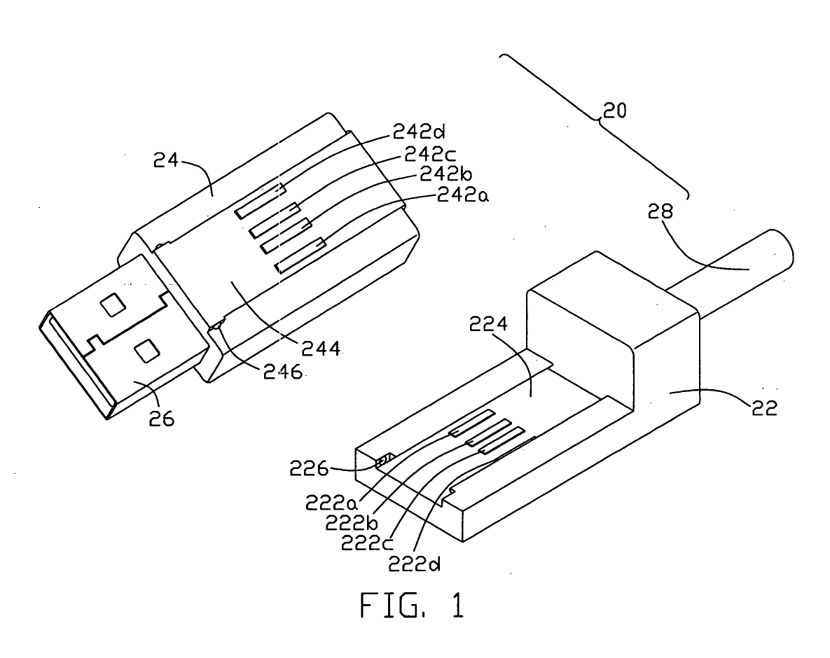

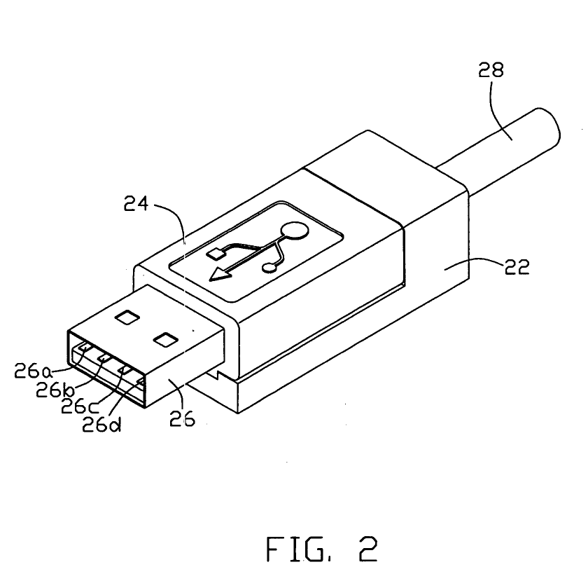

Referring to FIG. 1 and FIG. 2, a connector assembly in accordance with the present invention is applicable to a plug connector, a receptacle connector and/or a combination of the plug and receptacle connectors. Using a plug connector as an exemplary embodiment, a USB connector 20 includes a main body 22, a plug 26 with four signal pins 26a, 26b, 26c and 26d used as a connective interface for the USB connector 20, a plug module 24 and a cable 28 used as a connective means to provide further electrical connection for the USB connector 20. The main body 22 includes a dove-tail notch 224 with four signal pads 222a, 222b, 222c and 222d. The main body 22 further includes a pair of holes 226 at two opposite sides of the dove-tail notch 224. The cable 28 is linked to the main body 22 and connected to the signal pads 222a, 222b, 222c and 222d on a bottom surface thereof. The plug 26 formed in the plug module 24. The plug module 24 includes a dove-tail jut 244 with four signal pads 242a, 242b, 242c and 242d. The plug module 24 further includes a pair of knobs 246 at two opposite sides of the dove-tail jut 244. The signal pads 242a, 242b, 242c and 242d of the plug module 24 are connected with the signal pins 26a, 26b, 26c and 26d of the plug 26 respectively. The signals that the pins and pads transmit are shown in the following table:

| PIN | SIGNAL |
|---|---|
| a | VCC(+5 V) |
| b | D− |
| c | D+ |
| d | Ground |

When the plug module 24 is mounted to the main body 22 via the dove-tail jut 244 mating with the dove-tail notch 224, the knobs 246 of the plug module 24 are locked with the holes 226 of the main body 22. Thereby, the signal pads 222a, 222b, 222c and 222d are contacted with the signal pads 242a, 242b, 242c and 242d respectively.

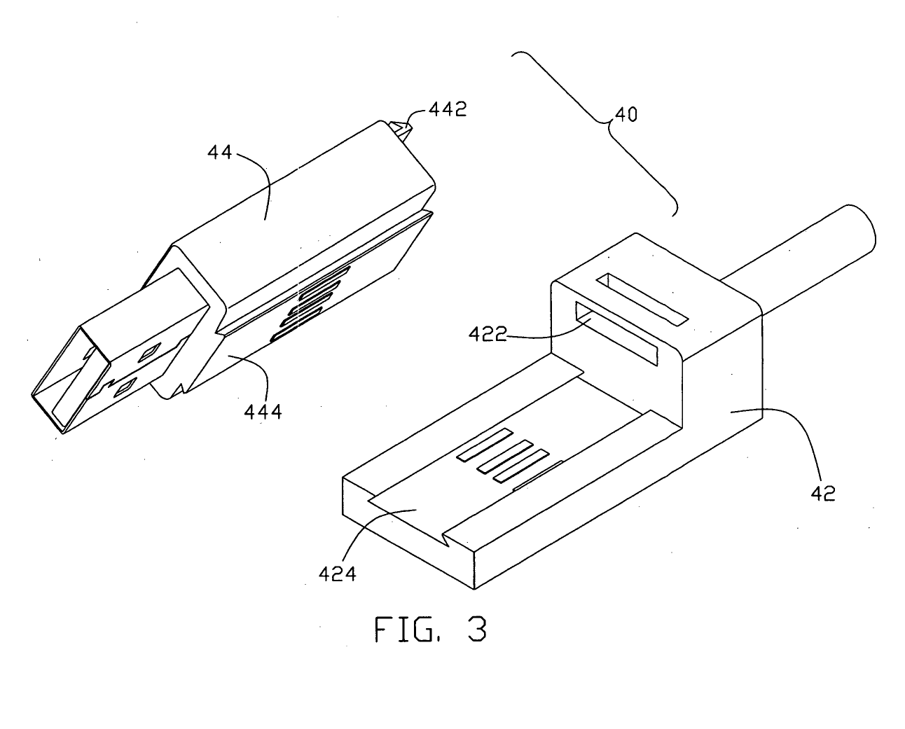

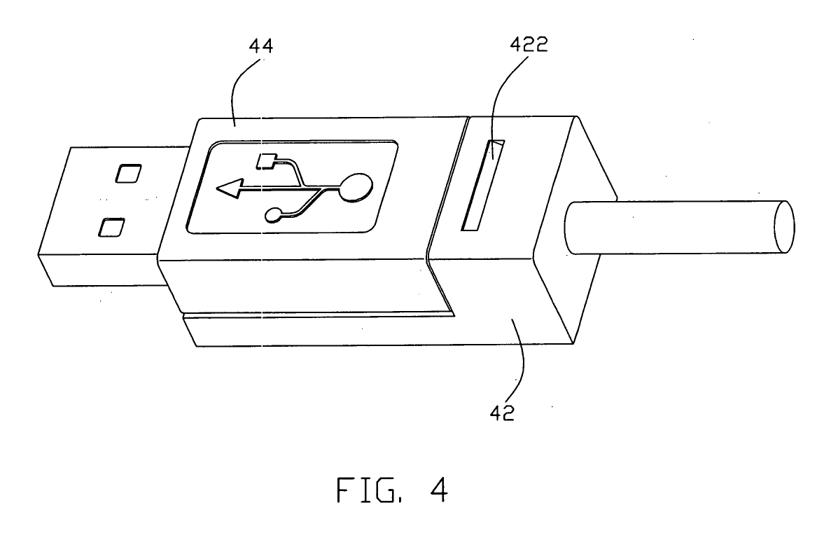

FIG. 3 and FIG. 4 show a USB connector 40 according to a second preferred embodiment of the present invention. As illustrated in FIG. 3, the USB connector 40 includes a main body 42 and a plug module 44 with a USB plug. The main body 42 includes an aperture 422 and a dove-tail notch 424 with four signal pads. The plug module 44 includes a hook 442 and a dove-tail jut 444 with four signal pads.

When the plug module 44 is mounted to the main body 42 via the dove-tail jut 444 mating with the dove-tail notch 424, the hook 442 of the plug module 44 is locked with the aperture 422 of the main body 42.

It is believed that the USB connectors 20 and 40 can replace the plug module 24 and 44 or the main bodies 22 and 42 expediently.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Universal Serial Bus (USB) connector comprising:
a main body;
a plug module detachably mounted to the main body;
a plug comprising a plurality of signal pins, the plug formed in the plug module; and
a cable linking to the main body and electronically connected to the signal pins of the plug.

2. The USB connector as claimed in claim 1, wherein the main body comprises a notch with a plurality of signal pads, and the plug module comprises a jut with a plurality of signal pads, the plug module is mounted to the main body via the jut of the plug module mating with the notch of the main body, the signal pads of the notch are respectively connected with the signal pads of the jut.

3. The USB connector as claimed in claim 2, wherein the notch and the jut are dove-tail shape.

4. The USB connector as claimed in claim 1, wherein the plug module is locked with the main body by an engaging means.

5. The USB connector as claimed in claim 4, wherein the engaging means comprises a pair of knobs at two opposite sides of the jut, and a pair of holes at two opposite sides of the notch.

6. The USB connector as claimed in claim 4, wherein the engaging means comprises a hook on the plug module, and an aperture in the main body.

7. A Universal Serial Bus (USB) connector comprising:
a main body connected with a cable; and
a replacable plug module detachably and slidably mounted to the main body, the plug module comprising a plug formed therein, and a plurality of signal pads formed thereon to be electronically connected to the cable.

8. The USB connector as claimed in claim 7, wherein the main body is L-shaped and comprises a recess for receiving the plug module.

9. The USB connector as claimed in claim 8, wherein a dove-tail notch is defined in a bottom of the recess, and a dove-tail jut is formed on a bottom surface of the plug module for slidably received in the notch.

10. The USB connector as claimed in claim 9, wherein a plurality of signal pads is formed on a bottom of the notch to be electronically connected to the signal pads of the plug module, and the cable is electronically connected to the signal pads of notch.

11. The USB connector as claimed in claim 9, wherein the plug module is locked with the main body via a pair of knobs at two opposite sides of the jut and a pair of holes at two opposite sides of the notch.

12. The USB connector as claimed in claim 9, wherein the plug module is locked with the main body via a hook on the plug module and an aperture in the main body.

13. A connector assembly comprising:
a main body of said connector assembly comprising a connective means for further electrical connection therewith; and
a physically separable module removably attachable to said main body, and defining a connective interface thereof to be capable of electrically interconnecting with other interfaces, said module capable of establishing at least one electrical connection between said module and said main body so as to electrically connect said interface to said connective means when said module is physically attached to said main body, and disabling said at least one electrical connection when said module is physically removed away from said main body.

14. The connector assembly as claimed in claim 13, wherein said connective means is a cable mechanically and electrically connectable to said main body.

15. The connector assembly as claimed in claim 13, wherein said connective interface is defined by means of a Universal Serial Bus (USB) plug integrally formed with said module.

16. The connector assembly as claimed in claim 13, wherein said at least one electrical connection is established by physical engagement of a pair of signal pads, one of said pair of signal pads is formed on said module and the other of said pair of signal pads is formed on said main body.
